(19) United States
(12) Patent Application Publication
(10) Pub. No.: US 2018/0321651 A1
(43) Pub. Date: Nov. 8, 2018

(54) INTELLIGENT HOME ENERGY MONITORING AND MANAGEMENT SYSTEM

(71) Applicant: CyberPowered Home, LLC, Madison, WI (US)

(72) Inventors: William Blanchard, Madison, WI (US); Allen Nikka, Los Angeles, CA (US)

(21) Appl. No.: 15/972,089

(22) Filed: May 4, 2018

Related U.S. Application Data
(60) Provisional application No. 62/602,699, filed on May 4, 2017.

(51) Int. Cl. G05B 19/042; F24F 11/47; F24F 11/58; F24F 11/64; F24F 11/65; F24F 11/88

(52) U.S. Cl. CPC G05B 19/042; F24F 11/47; F24F 11/58; F24F 11/64; F24F 2140/60; F24F 11/88; G05B 2219/2614; G05B 2219/2639; F24F 11/65

(57) ABSTRACT

The present technology is directed to a system and method for regulating and optimizing energy consumption within a home based on intelligent control of electrical appliances and home-run circuits. The present technology taps into home-run circuits at the circuit breaker box in order to extract select set of parameters from current and voltage waveform required to identify the type and ON/OFF state of appliances or devices connected to each of the home run circuits. Therefore generating an active device list from which it construct contextual scene that reflect the level of occupancy and the condition of energy consumption in the house (i.e., where individuals are and what they are doing). Based on this information the present technology controls the actuation of home-run circuits, as well as the operation of HVAC system and a series of smart devices/systems in such a way so as to optimize the overall home/office energy consumption.

### CROSS-REFERENCE TO RELATED APPLICATIONS

The present disclosure claims priority to U.S. Provisional Patent Application No. 62/602,699, entitled “Home Monitoring and Control System,” filed on May 4, 2017; the entire contents of which is incorporated herein by reference in its entirety.

### TECHNICAL FIELD

The present disclosure generally relates to system and method for improved home energy monitoring and control. Specifically the present disclosure is directed to a system and method for optimizing home energy utilization based on contextual information.

### BACKGROUND

Smart homes have been hyped for several years but to this point are failing to deliver on this hype. One problem the smart home currently faces is the requirement included in many systems that the user must purchase an expensive upfront “hub” in order to have any smart devices working in the home.

Significant wasted energy in homes because homeowners don't have the time, desire, or foresight to use only the energy they need. In most homes lights and ovens are frequently left on. Air Conditioning is constantly running in many empty homes all across the country. The energy waste can be avoided by automatically controlling energy drains in the home with contextual understanding of the home.

Many of these systems fail to provide fast and reliable connections among the various smart home devices in a home. Many of these hubs fail to operate when not connected to the internet, and there is an operating lag when, as is the case with many systems, there is a requirement that they be operated via cloud control.

Furthermore, current systems fail to have an understanding of presence, general location, and activities of individuals in the smart home. In these systems, relevant information is only obtained from limited, expensive, and potentially invasive, sensors and fail to draw information from other sources. Thus requiring acquisition and installation of many sensors to achieve adequate functionality. As a result, these systems do not behave effectively until many smart home devices are installed in the home, at significant expense. In summary, there is a lack of contextual information about the home.

Electric utilities face unpredictable demand from their customers. This is increasingly troublesome for them as their generation sources become increasingly unreliable with the increasing use of renewables like wind and solar. They have an obligation to make supply to meet peak demand that is under strain from demand and supply. A system to automatically regulate many loads in a service area according to utility need makes it much easier to ensure demand matches supply. This system allows for automatic residential demand management that doesn't adversely affect homeowners, because it has a deep contextual understanding of homeowners needs.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 is a schematic illustration of an energy sensing system integrated within a circuit breaker box, in accordance to one embodiment of the present technology.

FIG. 2 illustrates a hardware representation of a breaker box with integrated energy sensing and device identification functionality, in accordance to one embodiment of the present technology.

FIG. 3 illustrates a operational overview for deriving contextual information from different on/off activity patterns of devices on home-run circuits, in accordance to one embodiment of the present technology.

FIG. 4 illustrates the role of user input in improving accuracy and efficacy of associating different electrical activity patterns on home-run circuits to corresponding contextual scenes associated with occupancy level and condition of a house, in accordance to one embodiment of the present technology.

While the disclosed technology is described herein by way of example for several embodiments and illustrative drawings, those skilled in the art will recognize that the disclosed technology is not limited to the embodiments or drawings described herein. It should be understood that the drawings and detailed description thereto are not intended to limit embodiments to the particular form disclosed, but on the contrary, the intention is to cover all modifications, equivalents and alternatives falling within the spirit and scope as defined by the appended claims. As used throughout this application, the words “can” or “may” are used in a permissive sense (i.e., meaning having the potential to), rather than the mandatory sense (i.e., meaning must). Similarly, the words “include”, “including”, and “includes” mean including, but not limited to.

### DETAILED DESCRIPTION

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### Example Embodiments

Disclosed are systems, methods, and non-transitory computer-readable storage media for energy monitoring and information collection within residential and/or business dwellings to determine contextual scenes and optimize power consumption through automated action and/or informing users via variety of means. Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

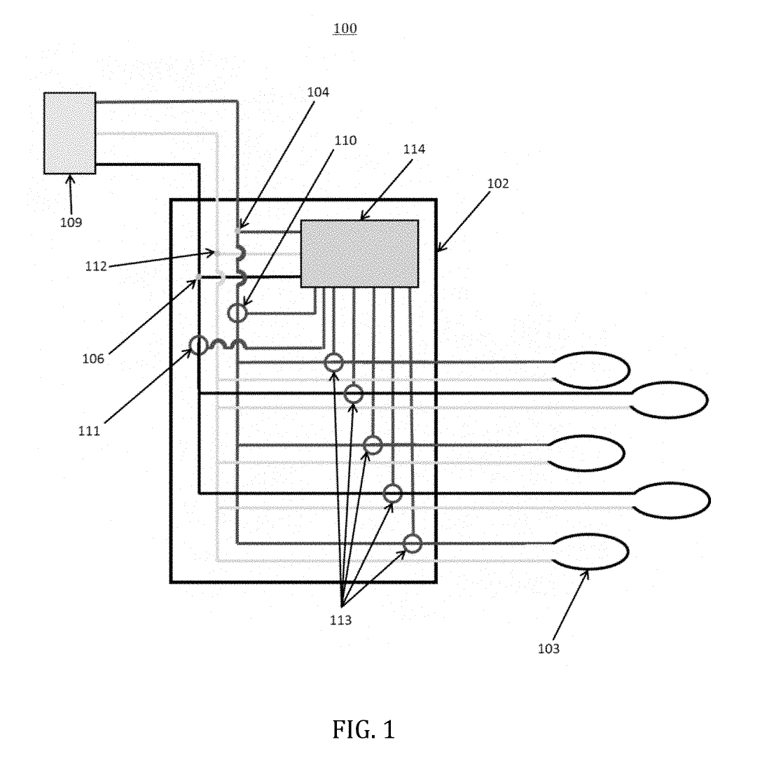

FIG. 1 illustrates an exemplary breaker box with integrated energy sensing functionality, in accordance to one embodiment of the invention. In the example configuration 100 of FIG. 1, energy sensing functionality is integrated within circuit breaker box 102 in such a way so as to enable sensing and/or measurement of current and voltage waveforms from one or more home-run circuits 103 connecting one or more appliances such as toaster, television, etc.

For the purpose of sensing voltage waveforms, unit 100 incorporates an adequately sized voltage divider to monitor both phases of voltage waveforms coming into the home and power the system. In the exemplary configuration 100 Voltage measurement for phase A and B are denoted by 104 and 106, respectively.

For the purpose of sensing current waveforms, Unit 100 incorporates a current sensing modality, such as split-core current transformers, to sense current waveforms on the two main power lines 107 and 108 coming into the home/office through a utility meter 109. Current measurement for phase A and B are respectively indicated by 110 and 111 in FIG. 1. Neutral voltage reference measurement is taken at 112. Current waveform is also sensed on all the branch circuits in the breaker box 102. High speed branch circuit current measurement is indicated by 113 in FIG. 1.

The measured waveforms may then be passed through some minimal analog circuitry to block any DC signal and filter out high frequency (i.e. greater than 5 kHz) noise. A high fidelity, high throughput, analog-to-digital converter may be used to digitize the aforementioned waveforms at a desired sampling rate (i.e., sampling rate of more than 20 KHz). The digitized information may then be transmitted via, for example, a serial peripheral interface (SPI) to a processor 114 (such as an Advanced RISC Machine based microcontroller) located inside the breaker box 102.

Once any artifacts, such as a phase delay, that may be introduced by the analog circuitry is corrected, desired parameters such as power factor, apparent, real, and reactive power of the waveform, along with high frequency harmonic information about the incoming current waveforms on branch circuits 113 are computed from the aforementioned waveforms. The high frequency harmonic information may comprise the phasor representations of the 1^{st} through 7^{th} harmonics of the current waveform, in accordance to one embodiment, which may be computed using a standard FFT algorithm implementation.

Although, the total power consumed and power consumed per circuit are derived from the processing of the voltage and current waveforms, according to one embodiment, it is only the reactive power portion of that calculation (which may be calculate directly using the input waveforms of current and voltage) along with the steady state current and the phasor angle for the 1^{st} through 7^{th} harmonics of current waveforms are extracted and utilized for the purpose of device or load signature identification. These features are additive, rather than multiplicative, thus allowing for later disaggregation of the loads.

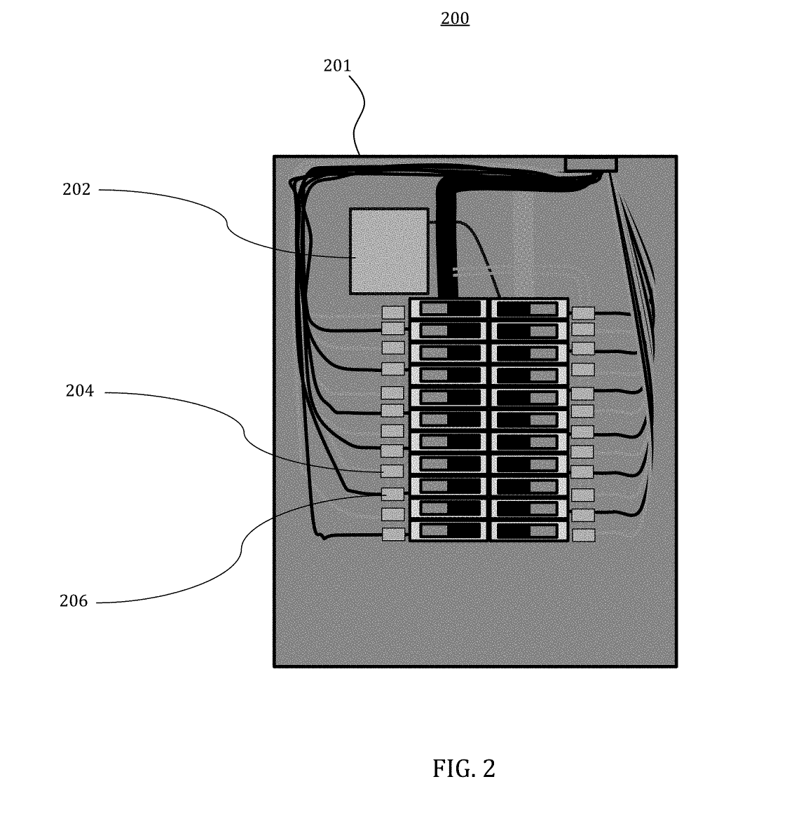

FIG. 2 illustrates an exemplary hardware representation 200 of breaker box integrated energy sensing and feature extraction unit 100 shown in FIG. 1. Exemplary hardware representation 200 is integrated within breaker box 201 as described above. Hardware configuration 200 comprises a connected breaker hub 202 for parsing sensor data provided by integrated sensing elements 204 which sense current and voltage waveforms directly from the one or more circuits connected through the breaker box 201. In addition to integrated sensing functionality, hardware unit 200 further constitute integrated control functionality 206 that enables individual circuit control for the circuits running through the breaker box.

In referencing the embodiment described above, features extracted by the integrated energy sensing system constitute a nine dimensional feature space data, comprising of the parameters (steady state current, reactive power and 1^{st}-7^{th} harmonics of the current waveform) that were extracted from the current/voltage waveforms propagating through one or more home run circuits in the breaker box. This information is then securely transferred to an external computing module such as a web-server, via a communication device/transceiver (i.e., 2.4 GHz dipole antenna) positioned outside the breaker box (necessary for wireless communication as the breaker box is a faraday cage) and connected to the breaker box integrated processor unit (114 in FIG. 1, also represented as connected breaker hub 202 in FIG. 2). The transmission of the extracted information to an external computing module may also be accomplished through power-line communication protocol between connected breaker box hub/processor and an external router.

The information can be communicated between breaker box hub and the internet via one of several standard modalities, however a feature of the disclosed technology involving processor/hub unit integrated in the breaker box enables several power-line communication improvements. For example, installing the hub in the central connection hub of power-lines (i.e., circuit breaker box), enables power-line communications to be passed in parallel across different circuits, in addition to duplicating power line communication across both voltage phases in the home, thus allowing uninterrupted power line communication regardless of power outlet selected. As such, as many signals may be passed simultaneously as there are circuits/circuit breakers in a breaker box. Therefore one advantage provided by select embodiments of the present technology, is the improved speed and reliability of communication between smart home devices as a consequence of utilizing mesh wireless networks, power-line communication, and traditional communications cablings.

Furthermore, various embodiments of the technology may involve isolating circuits from power-line signals crossing between them, thus reducing errors in the signaling process and significantly improving speed and efficiency of power-line communications. Moreover, overlapping mesh radio frequency communication, traditional communication cabling, and power-line communication, as disclosed by embodiments of the technology, may enable transmission of more information, more quickly, with greater reliability, range and security.

As described above, the power consumption and harmonic information extracted by the energy sensing unit integrated in the breaker box may be transmitted to an external computing module (which, may comprise a web server) for further processing. One embodiment involves transmitting data only at times when there is a change in the steady state load on a breaker box circuit. This is possible because embodiments of the technology enable load disaggregation to be performed using only steady state measurements (versus commonly employed transient-monitoring approaches). Therefore, in accordance to an embodiment of present technology, the need to transfer lots of data between breaker box integrated hub unit and external computing module/web server is obviated without loss of information.

The transmitted data, comprising of parameters/features extracted from breaker circuit's current/voltage waveforms by the energy sensing unit as discussed above with respect to an embodiment of the technology, may be stored on the external computing module/web server in a dedicated database for a specific user, and separated based on the circuit in the home it was collected upon. Along with this information a corresponding delta parameter (change between the previous measurement for the circuit and the measurement now) is also stored in a separate table in the user's database. The Delta parameter (variation between consecutive measurements) is tracked as the information collected from each circuit constitute data points in a 9-dimensional feature space, in accordance to one embodiment of the technology, These stored deltas constitute the ‘device signatures’, that is, data points in a 9-dimensional feature space that may be used to uniquely identify various loads/appliances in the home.

According to an aspect of the technology, machine learning techniques (such as a standard Bayes classifier algorithm) may be used with each observed/recorded ‘delta’ events, to match the observed delta event to a previously detected load. If none is identified, a relevant user, for example the homeowner, may be prompted for which device has been turned on or off, and where it is in the house. This information is then stored alongside the ‘delta’ event that caused it on the computing module or server to facilitate identification of this load's activity in the future.

An index of previously seen loads may be used for the initial identification. Subsequently, a homeowner's input may be solicited to correct any erroneous identifications, an example such user prompt may be: “we think this is your TV turning on, is that correct?”

Using this method, in accordance to one aspect of the technology, the presence of individual devices (toaster, tv, etc.) on each circuit along with the ON/OFF status of each individual device is determined. By storing this index of devices seen on each circuit, and devices currently active, an active device list is maintained in the home. Abstracting up a layer, a second algorithm is then used that takes in as its feature set the predicted state of the home, and the state of devices in the home. According to one embodiment, this set of features may have 3 dimensions per device, namely ON/OFF status of the device, circuit the device is on, and a tag for the device category (TV, toaster, phone charger, LED light, incandescent light, etc.)

Device category tags are added automatically by the computing module or server whenever possible based on previous loads it has detected in the house in question (or others). In an event that the identification of a load corresponding to a new delta event cannot be made using an appropriate machine learning techniques, for example via a naïve Bayes matching to previous classified devices; the homeowner may be prompted for this information when the delta event of that device is detected.

According to one embodiment, using this feature set, and with a slight modification of a naïve Bayes classification algorithm, one can determine which state the home is in from a variety of common states supplied by the system, and custom states input by the homeowner. These could include states such as: everyone's home in the evening around the house, everyone's home in the morning in the kitchen, no one is home, one person is home watching TV, etc.

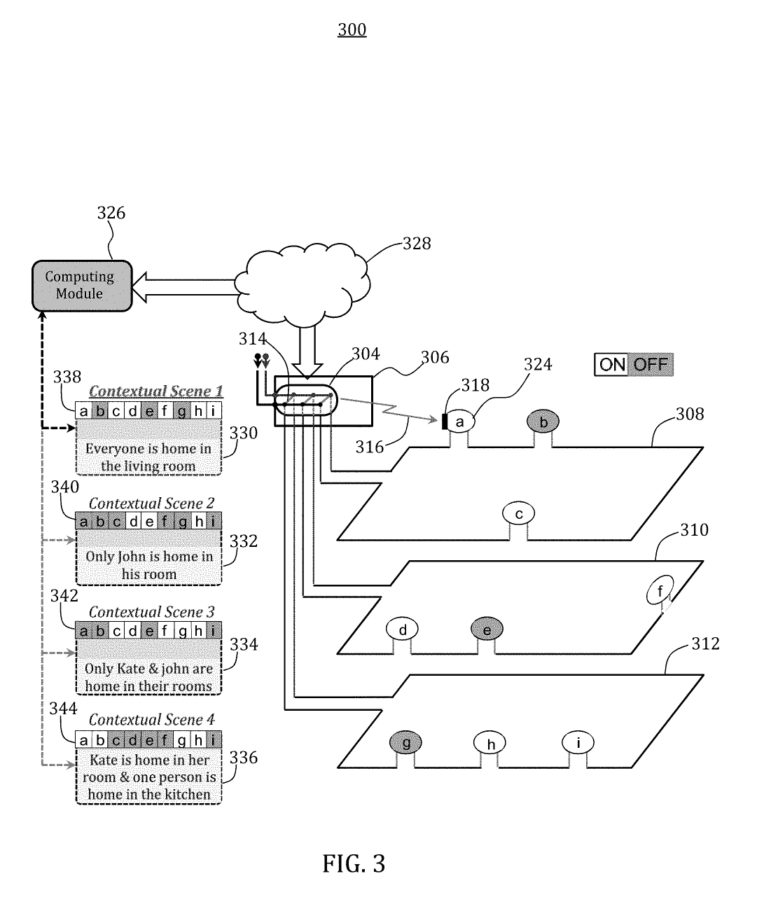

The exemplary system 300 in FIG. 3 illustrates the aspect of the present technology as directed to going from device recognition to building contextual information for achieving contextual awareness that may then inform a set of action. In other words, the illustrated embodiment relates to a process by which specific electrical activity pattern on one or more breaker circuits corresponding to a specific ON/OFF pattern or combination of various appliances/devices connected to the one or more breaker circuits maps to one or more contextual scenes (i.e. everyone is home and in the living room because the TV and living room lights are on). A set of actions may then be taken based on this determination.

System 300 comprises an energy sensing and feature extraction unit 304 disposed inside a circuit breaker box 306 and is electrically coupled to home-run circuits 308, 310 and 312 containing set of appliances/devices labeled ‘a’ through ‘I’. Unit 304 may be coupled to the home-run circuits in such a way so as to enable measurement of current and voltage waveforms from home run circuit connected through the breaker box 306 and furthermore to control an inline relays 314 disposed in series with one or more circuit breakers to activate/deactivate a particular circuit. In addition to controlling high amperage power switching relays 314 located in the breaker box, in line with home run circuits, full extent of the control functionality associated with the unit 304 in the exemplary embodiment 300 also include remote access/control link 316 established by unit 304 to a communication interface 318 of Appliance ‘a’ for example for controlling a smart thermostat using a wired or wireless access protocol. The remote access/control link 316 in the example of FIG. 3 is a WIFI based control link established to WIFI-enabled smart thermostat 318 for controlling HVAC unit 324.

System embodiment 300 also comprises a remotely located (relative to location of breaker box 306) computing module 326 in communication with breaker box integrated unit 304 over communication link/network 328. The computing module 326 maintains a mapping of different contextual scenes associated with various conditions of energy consumption in the house/office to corresponding ON/OFF patterns associated with state of devices ‘a’ through ‘i’. The information communicated to 326 in the embodiment 300 with regards to the ON/OFF combinations of appliances/devices ‘a’ through ‘i’ is compared with various stored contextual scenes 330, 332, 334, 336 encoded by corresponding stored sequences of device ON/OFF patterns 338, 340, 342 and 344, and maps to contextual scene 330 corresponding to everyone is home in the living room condition.

In accordance to the embodiment illustrated in FIG. 3, a type of action taken based on derived contextual scene of a home/office may be Wi-Fi based control as in 320 to control a smart device via a communication interface a , or in-relay based (such as in-line rely 307) to take action at circuit level.

The exemplary system configuration 300 incorporates both circuit-level control (activate/de-activate home-run circuit 312 through in-line relay 307) and WIFI-based smart component control (i.e., controlling an operational duty cycle of appliance 324 by interfacing with communication interface 322)

Although device/energy use data may be used in absence of other inputs and sources of information to create a strong contextual model and inform significant action with a high degree of confidence, in accordance to some aspect of the invention contextual information may be derived from various sources besides and/or in addition to energy/device data. These sources comprise of temperature sensors, motion sensors, cameras, microphones, other smart device inputs (i.e., TV communicating to the system the content being displayed), among others.

In one embodiment, the control may encompasses both circuit-level control and internet access control that may be based on wired or wireless protocol to implement smart component control (i.e., controlling an operational duty cycle of an HVAC system by interfacing with the smart thermostat unit)

According to different embodiment of the present technology control action informed by determination of contextual scene of the house may be accomplished through various different internet based protocols such as Wi-Fi, cellular, LAN, or otherwise.

According to one aspect of the technology, infrequent prompts to a relevant user, such as the homeowner, may be used to validate and reinforce the learned device feature set to home state mapping. This feedback loop allows the classification algorithm to change the weights of different features in the feature space to better map to the correct state for the home in question over time.

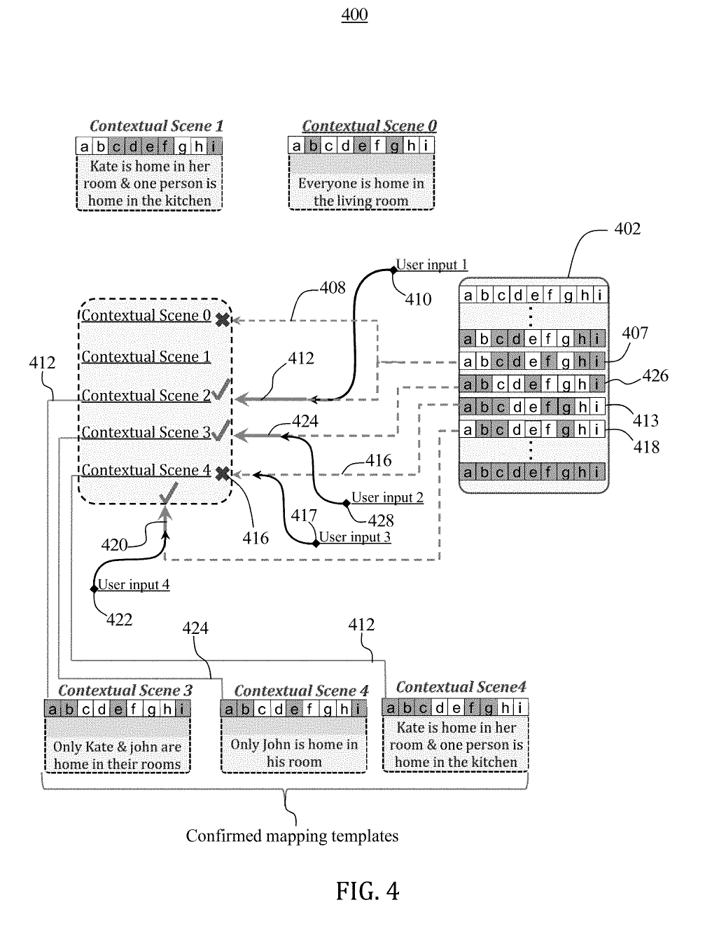

FIG. 4 illustrate role of user input in correcting system mistakes with regards to contextual scene creation and mapping to ON/OFF activity profile of electrical devices and appliances connected to the home-run circuits. The exemplary embodiment of system operation 400 402 represent all possible combination of ON/OFF device state across all sensed/measured circuits in the home/office.

Electrical activity pattern (ON/OFF combination) 407 is determined to align with contextual scene 0 through mapping 408 as well as contextual scene 2 through mapping 412—in such situations, the derived mapping may be further narrowed to a single contextual scene through input from a user (i.e., homeowner). In the example 400, user input 410 is solicited to verify the correct mapping of the electrical activity profile 407. By utilizing the User input 410, mapping 408 which associates the observed electrical activity pattern 407 to contextual scene 0 is invalidated and discarded in favor of mapping 412 which now correctly maps the observed electrical activity pattern 407 to contextual scene 2. Therefore mapping 412 is stored in the system (i.e., computing module 326) as a template for future reference.

Referring back to FIG. 4, Electrical activity profile 413 is associated with scene 4 across mapping 416. User verification provided via user input 417 invalidates mapping 416. The system subsequently re-computes and re-associates scene 4 to electrical activity profile (On/OFF device pattern) 418 through mapping 420 which is confirmed by user input 422. Consequently, mapping 420 is stored in the system as a template for future reference. Another scenario depicted in the exemplary embodiment 400 involves system derived single mapping 424 which associates electrical activity profile 426 with contextual scene 3. In absence of any apparent discrepancy, the derived mapping 424 may then be stored in the system as a template for future reference or the system may hold off on storing the mapping as a template pending receipt of confirmation via user input 428.

Predicted state of the house will be addressed below.

Prediction of contextual states abstract up one more layer, again using a slightly modified naïve Bayes classifier that takes in a 3 (or more)+α+β dimensional feature set. α is the number of smart devices that are integrated to the system in the house (i.e. a Honeywell smart thermostat that the present technology may override and control via the associated open API), and β indicates the number of circuits in the smart breaker box that have in-line relays installed, which can vary depending on the home size. The 3 other features, in accordance to one embodiment, may be the outdoor temperature forecast, electricity price forecast from the utility, and scheduling input from the homeowner (but could include other information). The scheduling input from the homeowner may be both pre-programmed and prompt based, according to different embodiments, and commands the desired activity of all the devices controlled by the system. That is, example scheduling inputs could include “lights (i.e. dedicated lighting circuits) shut off via relay during the day if they are left on and no one has turned any electric devices on or off manually in the last 20 min” or “have the house at 70° F. at 7 pm on weekdays” or even, based on the contextual data the system has, = have the house at 70° F. when it is in the state of ‘everyone's home in the evening around the house’. This demonstrates the extent of the control functionality in accordance to one embodiment of the present technology, which involves both controlling high amperage power switching relays located in the breaker box, in line with home run circuits, and controlling, for example, a smart thermostat based on full contextual understanding of the home.

In accordance to one aspect of the technology, for each of the contextual scenes there is an optimal state of all the appliances and circuits that may be controlled. I.e. for the HVAC units controlled using internet protocols, and the home-run circuits controlled using in-line relays, for any given recognized state of the home there is an optimal setting of the HVAC and on/off states of the circuits.

According to one embodiment of the technology, the majority of the contextual data comes from the circuits that may not be suitable to directly modulate (because they are not dedicated lighting circuits etc.), therefore the exemplary embodiment may not be turning off the loads it uses to determine scenes, but rather uses the determined scene to dictate the state of the (relatively fewer in number but significantly higher in total energy consumption) appliances and circuits (lighting, HVAC, water pumps, water heaters) that are directly controllable. In one aspect, the appliances and circuits are directly controllable via smart device API integration or in-line relays on their dedicated circuits.

The last home owner scheduling example may highlight an additional layer of abstraction the present system, predictive modeling of the home. Using aggregate historical weekly data, the system then predicts the states of the home during the upcoming week via averaging and forward propagating the aggregate states on a hour by hour bases of the previously recorded weeks. This predictive model then feeds forward into the state prediction classifier mentioned above.

One aspect of the present technology involves demand smoothing to automatically adjust electric load in response to price signal from a utility company. Shifting demand from peak demand times to times with less demand will allow electric utilities to build less total energy generation capacity and also run fewer peaking plants. Another aspect is directed at demand prediction, by helping electric utilities better predict demand thereby allows them to reduce the need for peaking plants less, and better plan their demand. On a longer scale, better demand prediction will also give utilities insight into the factors that tend to drive their profitability.

Yet another embodiment of the technology involves demand-event response. When demand does threaten to out-pace the supply of the utility, the present technology will allow the demand to be cut nearly instantaneously. This prevents the need for the utility to cut the electric supply in a less granular and targeted manner, thereby allowing them to maintain strong customer relations and run operations with less buffer. This saves costs while also increasing utilities' reliability.

Therefore, in accordance to an embodiment, price signals may be received from utility company in response to which electric loads in a home may be modulated in such a way so as to limit the loads when the price signal is high and use loads more freely when the price signal is low. This limiting of demand when the price signal is high will allow the utility, by publishing a simple price signal, to smooth demand. The publishing of a significantly higher price signal can also serve for demand event response. Causing the system to limit electric demand abruptly in the case

Another embodiment involves accepting price signals and using the same to not just limit demand during high demand times but also shifts demand (demand smoothing). One example is to prevent a device from running during a high demand time and instead schedule it to run later. (e.g dishwasher could be automatically scheduled for 3 a.m. instead of 7 p.m. after dinner, this could be done automatically by the present system, and overwritten by a homeowner in the unusual case that the homeowner cares that the dishwasher runs at 7 p.m.)

Another possibility is to run a more complex control system for HVAC systems. Which introduces a wider window for the HVAC temperature setting, and then pulls more energy to conduct more heating/cooling during low energy times to then have excess heat/“cool” in the home to sustain reasonable temperatures during high demand times.

One embodiment of the present technology involves integrating monitoring of the energy use as earlier described to create even more intelligent HVAC control. This will create even more insight into the number of occupants in a home, whether anyone is home, how the occupants are distributed, etc. This type of information is easily gathered based on which electric devices are running, thus allowing for more appropriate HVAC functioning. For example, not heating/cooling when no one is home and there has been no electric draw over a significant time, but kicking on when a garage door opens.

Another embodiment is directed at helping utilities predict demand with greater accuracy by building models to predict electric draw based on present technology which features a more granular data of how the electric loads are used by device, by time of day, by correlating events to develop robust models of how electric is used in homes, this can then be used to project electric use by home and then can be aggregated across all the homes where the disclosed devices/system is installed. The granular data, the models, the projections both granular and in aggregate would all be useful to utilities. By helping utilities predict demand better utilities are able to avoid using peaking plants which are used are great expense to utilities.

Although several embodiments of the technology are directed to systems and methods that solely utilize energy data read/sensed from one or more power distribution circuit running through a circuit breaker box to satisfy all required criteria, thus obviating a need to have any other sensing modality installed and configured. In some embodiments, additional information such as time, date/day of week beyond device usage may be utilized.

Additionally, other embodiments may be directed to the use of multiple sensors such as temperature, motion sensors, humidity, microphones, cameras, etc. Other embodiments involve taking in data from smart devices, for example, temperature from thermostat, entry and exit from door lock or garage door, Data from computers, TVs, phones, etc (i.e., what media is being viewed on TV, what application in use on the smart phone). Further embodiments may be directed to homeowner inputs and corrections provided through, for example, web and mobile applications.

in order to provide additional information beyond device usage including such as thereby provide the capability of adding supplementary hardware/software which might be needed to support some aspects the system.

Different embodiment of the disclosed technology describe features and functions that enables interoperability, among others features, benefits and advantages have also been enabled by inventive features disclosed in the context of various embodiments and examples of the present technology.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A system for intelligent management of home energy consumption comprising:
a first module disposed in a vicinity of a breaker box and operatively coupled to one or more circuits in the breaker box; and
a second module communicatively coupled to the first module, wherein the first module further comprises;
a first unit configured to periodically transmit information corresponding to one or more selected features, extracted from one or more signal waveforms propagating in each of the one or more circuits, to the second module; and
a second unit configured to control an energy utilization activity of one or more electrical elements based on an output of the second module; wherein
the second module is configured to map one or more patterns of electrical activity on the one or more circuits in the breaker box to one or more corresponding contextual scenes based upon the periodically transmitted information from the first unit of the first module; and
output one or more control signal to the second unit of the first module to thereby optimize the home energy consumption in accordance to each of the one or more contextual scenes.

2. The system of claim 1, wherein the signal waveform corresponds to one or more voltage and current waveforms.

3. The system of claim 1, wherein the plurality of additive features comprises a steady state current parameter.

4. The system of claim 1, wherein the one or more additive features comprises a reactive power parameter.

5. The system of claim 1, wherein the one or more additive features comprises a phasor angle for the first through seventh harmonic components of the current waveform.

6. The system of claim 1, wherein the mapping of one or more patterns of electrical activity in the one or more circuits in the breaker box onto one or more corresponding contextual scenes is further based on one or more inputs from one or more designated users.

7. The system of claim 1, wherein the control of an energy utilization activity of one or more electrical elements comprises activation and deactivation of one or more relay elements disposed inside the breaker box and in-line with the one or more circuits.

8. The system of claim 1, wherein the control of an energy utilization activity of one or more electrical elements comprises remotely accessing one or more control interfaces coupled to one or more appliances, to thereby modulate the energy consumption of the one or more appliances.

9. The system of claim 8, wherein the one or more control interfaces coupled to one or more appliances comprises a smart thermostat coupled to an HVAC system.

10. The system of claim 8, wherein the remotely accessing one or more control interfaces is established via one or more wireless access protocols.

11. The system of claim 8, further comprising controlling a switching action of one or more relay elements disposed in series with one or more circuit breaker in the breaker box, to thereby modulate the energy consumption of the one or more appliances

12. The system of claim 1, wherein the one or more patterns of electrical activity on the one or more circuits corresponds to one or more combinations of ON/OFF states associated with one or more appliances on the one or more circuits.

13. The system of claim 1, wherein the second module is communicatively coupled to one or more appliances via one or more network access protocols and generates one or more control signals to directly control the energy utilization activity of one or more electrical elements based on the one or more contextual scenes.

14. The system of claim 1, wherein the mapping of one or more patterns of electrical activity in the one or more circuits in the breaker box onto one or more corresponding contextual scenes is further based on one or more inputs from one or more sensors and smart devices.

15. The system of claim 1, wherein the controlling of the energy utilization activity of the one or more electrical elements is further based on information regarding electric energy availability and variable pricing from a utility power provider.

16. The system of claim 15, wherein the controlling of the energy utilization activity of one or more electrical elements is further directed to match high energy utilization activity of the one or more electrical elements to high electric energy availability from the utility power provider.

17. The system of claim 15, wherein the controlling of the energy utilization activity of one or more electrical elements is further directed to match low energy utilization activity of the one or more electrical elements to low electric energy availability from the utility power provider.

18. A method for automatically optimizing home energy utilization comprising:
extracting a plurality of selected features from one or more measurements of current and voltage waveforms drawn from one or more circuits in a breaker box;
storing each of the plurality of selected features along with a respective variation recorded between consecutive measurements for each of the one or more circuits, to thereby identify types and an ON/OFF status of one or more devices on each of the one or more circuits;
creating one or more contextual scenes based on the types and the ON/OFF status of the one or more devices on each of the one or more circuits; and
controlling an energy utilization activity of one or more electrical elements in accordance to each of the one or more contextual scenes.

19. The method of claim 18, wherein the plurality of selected features comprise a steady state current.

20. The method of claim 19, wherein the plurality of selected features further comprise a reactive power.

21. The method of claim 18, wherein the plurality of selected features comprise a phasor angle for the first through seventh harmonics of the current waveform.

22. The method of claim 18, wherein the creating of one or more contextual scene is further based on one or more inputs from one or more users.

23. The method of claim 22, wherein the creating of one or more contextual scene is further based on one or more inputs from one or more sensors and smart devices.

24. The method of claim 18, wherein the controlling of an energy utilization activity of one or more electrical elements comprises remotely accessing one or more control interfaces coupled to one or more appliances connected to the one or more circuits, to thereby modulate the energy consumption of the one or more appliances.

25. The method of claim 24, wherein the one or more control interfaces coupled to one or more appliances comprises a smart thermostat coupled to an HVAC system.

26. The method of claim 24, wherein the controlling of an energy utilization activity of one or more electrical elements further comprises actuation of one or more relay elements disposed inside the breaker box and in-line with the one or more circuits.
